(19) United States
(12) Patent Application Publication
(10) Pub. No.: US 2015/0019952 A1
(43) Pub. Date: Jan. 15, 2015

(54) SYSTEMS AND METHODS FOR PROVIDING AND UTILIZING USER-SPECIFIC INFORMATION

(71) Applicant: Ad-Vantage Networks, Inc., Glendale, CA (US)

(72) Inventors: David S. Grant, Mission Viejo, CA (US); Sanjeev Kuwadekar, Northridge, CA (US)

(21) Appl. No.: 14/200,616

(22) Filed: Mar. 7, 2014

Related U.S. Application Data
(60) Provisional application No. 61/790,237, filed on Mar. 15, 2013.

(51) Int. Cl. G06F 17/30; G06Q 30/02

(52) U.S. Cl. CPC G06F 17/30887; G06F 17/30867; G06Q 30/0255
USPC 715/234

(57) ABSTRACT

Systems and methods for providing user-specific information and utilizing user-specific information for web applications are described. A user query is received and appended with a temporary ID which contains information related to the user. The appended user input is provided to an application. An indication that the application wishes to unlock the temporary ID is received. The temporary ID is unlocked and information about the user is sent to the application. An item of value may be provided for a valid temporary ID and/or to unlock the temporary ID. The temporary ID is changed and/or associated with a null value or inaccurate data. The application may then provide another item of value for a valid temporary ID and/or to unlock the temporary ID, in order to receive certain information related the user.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57.

### BACKGROUND OF THE INVENTION

1. Field of the Invention

The systems and methods disclosed herein are directed to online advertising, and more particularly, to targeted online advertising based on user-specific information.

2. Description of the Related Art

Currently, there are many websites that host advertisements. These websites desire information about the users visiting their websites so that they may provide advertising that is targeted to the user visiting their website. Targeted advertising can provide the user with a better browsing experience. In addition, targeted advertising can increase the likelihood that the user will click on an ad, generating more revenue to the website or network access provider. Further, merchants that advertise through the website also benefit through increased traffic to their sites.

### SUMMARY OF THE INVENTION

The present invention is related to methods and systems for identifying and presenting information, such as information related to a search query or with respect to an electronic representation of data (e.g., a Web page, content stream, data provided via a service or application, etc.).

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example embodiment provides a method of processing a uniform resource locator (URL) request from a user and providing venue information to an application node, the method comprising: receiving, at a network node, the URL request from a user terminal; causing, at least in part, a temporary identification to be associated with the URL request, wherein the temporary identification is associated with venue information regarding a venue associated by location with the user terminal; automatically appending the URL request with at least a portion of the temporary identification, wherein the temporary identification is locked; transmitting the modified URL request, including the locked temporary identification over a network to an application node; receiving at the network node, from the application node, a request to unlock the locked temporary identification; and at least partly in response to the request to unlock the locked temporary identification, transmitting the venue information to the application node.

An example embodiment provides a method of processing input from a user and providing user information to an application node, the method comprising: receiving, at a network node, the user input from a user terminal; causing, at least in part, a temporary identification to be associated with the user input, wherein the temporary identification is associated with information about the user; modifying the user input based at least in part on the temporary identification; transmitting the modified user input to an application node; receiving from the application node a request to unlock the temporary identification; and transmitting the user information user to the application node.

An example embodiment provides tangible, non-transitory media configured to store a program that when executed by a processor is configured to perform operations, comprising: receiving, at a network node, a user input from a user terminal; causing, at least in part, a temporary identification to be associated with the user input, wherein the temporary identification is associated with information about the user; modifying the user input based at least in part on the temporary identification; transmitting the modified user input to an application node; receiving from the application node a request to unlock the temporary identification; and transmitting the user information user to the application node.

An example embodiment provides a method of processing input from a user the method comprising: receiving, at a network node, a user input from a user terminal; causing, at least in part, a temporary identification to be associated with the user input, wherein the temporary identification is associated with information about the user; and modifying the user input based at least in part on the temporary identification.

An example embodiment provides a method of providing user information to an application node, the method comprising: receiving from the application node a request to unlock a temporary identification, wherein the temporary identification is associated with user information in a database accessible by the network node; and at least in part in response to receiving the request, accessing the database to retrieve user information associated with the temporary identification; and transmitting the user information user to the application node.

### BRIEF DESCRIPTION OF THE DRAWINGS

FIG. 1 illustrates a system for sending user-specific information to a web application.

FIG. 2 illustrates a system for sending user-specific information to a web application through a centralized computing system.

FIG. 3 illustrates a system for utilizing user-specific information for a web application.

FIG. 4 illustrates an example process for providing user-specific information, which may optionally be implemented by software installed at, and executed by a network node or otherwise.

FIG. 5 illustrates a revenue model according to an example embodiment

### DETAILED DESCRIPTION OF PREFERRED EMBODIMENTS

Venues that provide network access, such as internet access (e.g., via a wired and/or wireless network) often possess valuable user-specific information. Such venues can include hotels, coffee shops, airports, universities, stadiums, retailers, or any other suitable location. The venue may possess/acquire information about a user through a variety of means. For example, the venue operator may possess information about products or services a user requested or purchased at the venue, as well as reservations made by the user. If the user is a regular customer, the venue operator may further possess information about the spending patterns of the user. The user's purchase(s) may reveal further information about the user's general preferences, demographic information, hobbies, etc. As another example, when a user attempts to log on to the internet at the venue, the user may be asked some basic information about himself/herself such as gender and age. As another example, a venue may possess information about a user through a check-in process at a hotel or airport. Thus, through various means, a venue may possess demographic information, occupation, location of a user's residency, and other valuable information about a user. Such user information may be stored in a data store, such as a database. In addition to the user information, derived anonymous data may be stored in the data store.

Because user-specific information is valuable to site operators (e.g., website operators), they are willing to pay a fee to acquire this information. In particular, operators of websites that host advertisements desire information about the users visiting their website in order to provide targeted advertising and/or other information. As used herein, “ad-host” refers to websites that host advertisements. Examples of ad-hosts include search engines, blogs, websites reporting current news, and websites through which third party merchants sell merchandise, such as eBay®.

With user-specific information, ad-hosts may provide targeted advertising. For example, a venue might inform an ad-host, for a fee, that a user is at a luxury hotel. Such information may be transmitted over a network from a venue system and received by the ad-host system. Based at least in part on this information, the ad-host may select and provide for display ads for luxury merchants to the user via a user terminal (e.g., a laptop, desktop computer, tablet computer, smart phone, interactive television, game console coupled to a display, etc.). Optionally, the ad-host may select ads for luxury merchants within a specified proximity to the user's current location (e.g., within a certain distance of the luxury hotel as which the user is residing). As used herein, “ads” or “advertisements” include images, photographs, videos, audio, text documents, graphics, and/or a references, such as references to network resources (e.g., a URL link).

However, once an ad-host purchases or otherwise obtains the user-specific information, the ad-host can store that information in its database and continue to use that information and/or can access such information from an external database, such as that of the information provider. For example, the ad-host may use the information each time the user visits different sub-pages of the ad-host's website, each time the user returns to the website after navigating to a different site, each time the user refreshes a browser, each time the user submits a search query on a search engine website, and/or for as long as the user is at the website. Optionally, such information is used periodically, rather than each time, in the foregoing examples.

Accordingly, in an example embodiment, an ad-host is sent a temporary unique ID associated with user-specific information that the ad-host desires. The temporary unique ID may be “locked” in that it is encrypted, masked, symbolic, or otherwise obscured to the ad-host. The locked temporary ID may then be “unlocked” by being decrypted, unmasked, deciphered, or otherwise revealed. In order to unlock the temporary ID and obtain the user-specific information, the ad-host pays (e.g., acting for the ad-host operator) a fee, such as a fee to a venue providing network access (e.g., via a wireless hotspot, or a wired network connection) according to an example embodiment. When the temporary ID expires, the ad-host pays another fee to the venue to obtain a valid temporary ID according to an example embodiment. In one embodiment, the ad-host pays another fee to unlock the temporary ID. Optionally, the ad-host may enroll in a subscription service, and may automatically receive ID(s) on an as needed basis without having to pay a separate fee for each ID. In some embodiments, payment from the ad-host may be made to an intermediary or service provider, which may then pay the venue and/or individual user or user delegate. As will be understood, “payment” as used herein may refer to an indication of an incurred credit or debit, as opposed to the actual transfer of currency. For example, an ad-host might “pay” a venue provider by indicating that payment will be owed to the venue by the entity associated with the ad-host. The associated entity may then provide the actual transfer of currency to the venue separately, and/or at a later date.

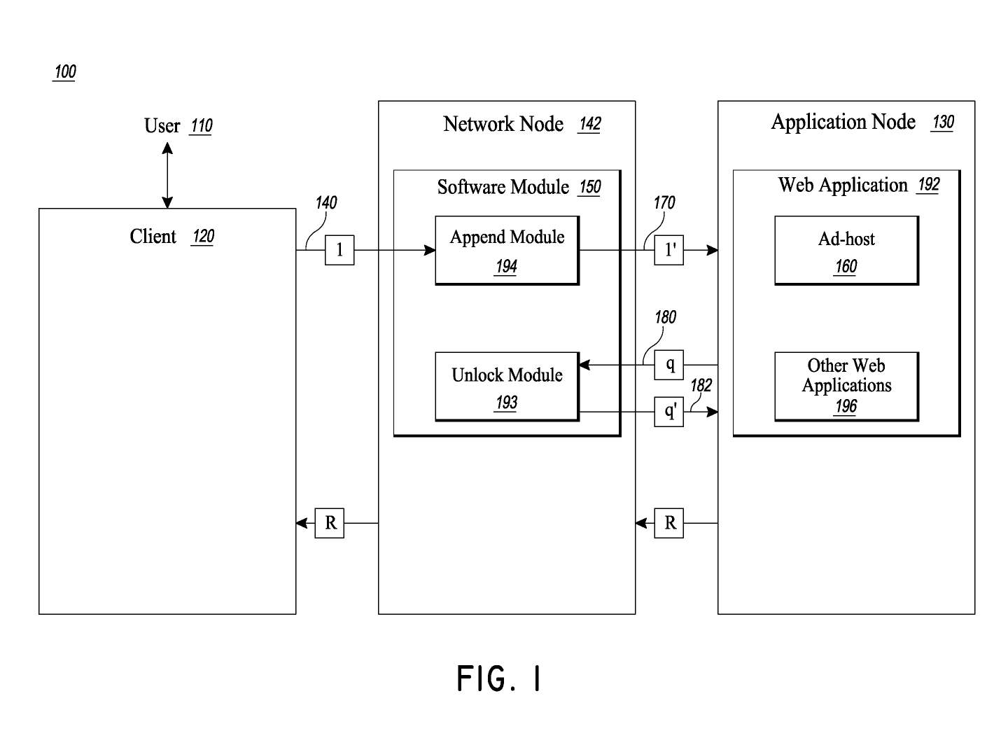

FIG. 1 illustrates an example system architecture 100 configured to collect and provide information about a user 110 to an application, such as a web application 192, which includes an ad-host 160 and other web applications 196. In some embodiments, the ad-host may be a third-party, separate from the web application. As illustrated in FIG. 1, a user 110 submits, via a user terminal 120, a user input (e.g., a query) 140 to the application node 130 via a network node 142, and internet web application node 130 returns a webpage over a network (e.g., the internet) to the user 120 terminal via the network node 142. The network node 142 may be an internet access system in the form of a wireless (e.g., Wi-Fi) or wired (e.g., Ethernet) hot-spot. An example embodiment comprises a module 150 (e.g., a software and/or hardware module) configured to monitor and modify data packets sent between the user 110 and the application node 130. The module 150 may be installed locally at the internet access system, may be accessible through a central server, and/or may be accessible on a “cloud.” As used herein, “module” may include any combination of the above.

In some embodiments, the network node 142 may be a proxy or collaboration system. For example, the node may comprise a router in the network through which data packets are sent to and from the user 110. In some configurations, the network node 142 may be positioned so as to receive only inbound data packets to the user or outbound data packets from the user. In some embodiments, a plurality of network nodes may be provided, in which one receives outbound data packets from the user, and another receives inbound data packets to the user. In some embodiments, the network node can comprise a cloud-based system. For example, the user may type “www.ad-host.com” and search for Asian Food. The proxy, collaboration system, or intermediate module appends “proximity=abcxyz&cookie-info=aabbccdd”. The ad-host server or a third party service acting in concert (e.g. cnn.com with Google search bar) can receive the search criteria appended with a temporary ID. The ad-host or third party may parse the data, and then call an API and pass the temporary ID to be unlocked. In response, user-specific information, such as “Hyatt hotel at 22 S. Main, NY,” can be provided so that the ad-host or third party can improve the resulting page.

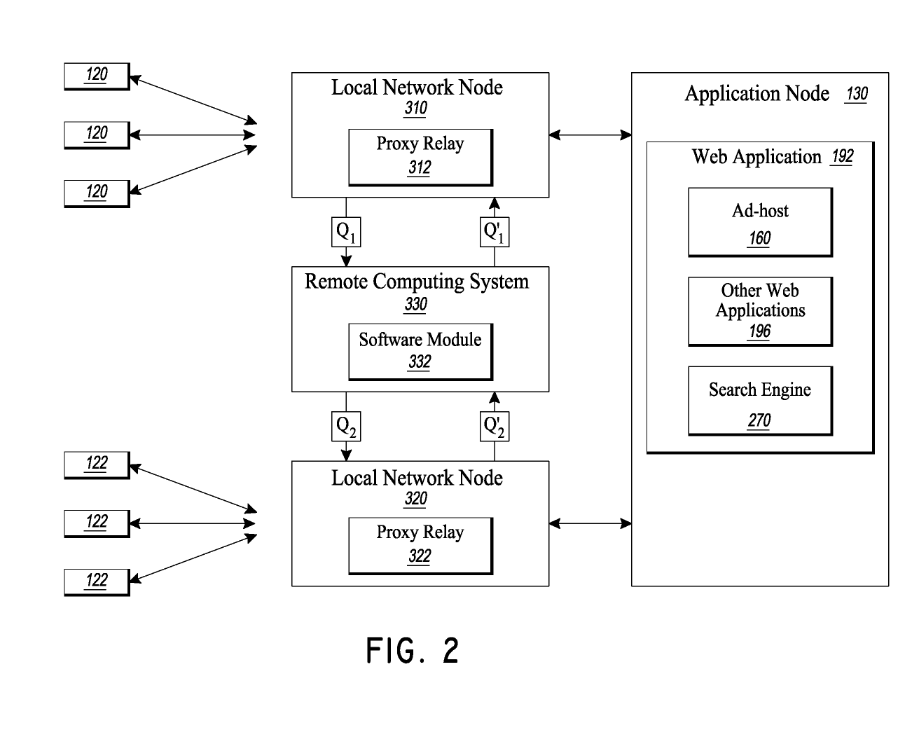

FIG. 2 illustrates an example system architecture configured to provide information about a user 110 to a web application 192 through a centralized remote computing system 330. The remote computing system 330 includes module 332 configured to monitor and modify data packets transmitted by clients 120, 122 at the local network nodes (e.g., hot-spots), as similarly discussed elsewhere herein. The local network nodes may access the module 332 via a proxy relay 312, 322. Referring to FIG. 1, the user input 140 may comprise the user 110 typing a domain name, such as www.adhost.com. The user input 140 may also comprise any action by the user 110 that changes or affects the content of the webpage the user 110 is currently browsing. For example, the user input 140 may comprise the user's 110 navigating to sub-pages at a webpage, clicking on a link, submitting different search queries to a search engine, submitting different search queries at a webpage with a search feature, refreshing the browser, and so forth. Each time (or for selected inputs) the user 110 submits a user input 140, a web application 192 can select an advertisement to appear on the webpage provided for display on the user terminal 120, to be viewed by the user 110. Optionally, in addition, a web application 192 may be configured to change advertisements on a webpage in an interval between user inputs.

In an example embodiment, when a user 110 submits a user input 140, module 150, which may be located at a network access system 142, transmits a notification to the appropriate web application 192 that user-specific information is available, but optionally does not disclose what any or selective portions of such user-specific information. For example, if a user 110 is at a luxury hotel, the module 150 informs the web application 192 that information is available characterizing the type of venue the user 110 is at, but does not disclose that the venue is a luxury hotel.

In an example embodiment, a given user input 140 may be associated with a URL. Referring to FIG. 1, in one embodiment the module 150 comprises an append module 194, which appends the URL associated with the original user input 140 with a label and a locked temporary ID. For example, if the original user input 140 is www.adhost.com, the appended user input 170 may be www.adhost.com/?venue=10. The appended user input 170 informs the web application 192 that user-specific information is available. In this example, the label is “venue,” which informs the web application 192 that user-specific information about the venue is available, and the locked temporary ID is “10.” The web application 192 may receive, interpret or decode, and store the appended text. Unlocking the temporary ID will allow the web application 192 to receive user-specific information, such as information that the user is at a luxury hotel. When the web application 192 only has the locked temporary ID (e.g. “10”), the web application 192 is not informed of the user-specific information. In some embodiments, the locked temporary ID may be a composite key that includes different levels of information available for purchase. For example, the first two characters may correspond to a first category with a first associated fee (e.g., $0.50/1,000 requests), while the next four characters may correspond to a second category with a second associated fee (e.g., a type or subtype of information available for an additional $2/1000 requests), etc.

It will be appreciated that the module 150 may append the user input 140 with any combinations of labels and temporary IDs. Thus, for example, www.adhost.com/?venue=10?demographic=20 may indicate that information about the venue, as well as the demographic of the user 110, is available.

As used herein, “append” refers to adding characters to a URL, or any other method of adding information to a user input 140. For example, modifications may be made to one or more of the following: From Field, Session Variables, HTML hidden or post variables, a query string, AJAX feed, HTML Post, or Cookies. To unlock, the ad-host may call webservices or an API with authorized access. Access may then be throttled, controlled, denied, etc. based on one or more of standing, payment history, usage, etc. of the ad-host.

The temporary ID appended to a user query 140 may comprise any combination of alphanumeric or other characters. For example, venue=1AC475cF89 may represent a luxury hotel. In addition, individual user data may be used to create a unique temporary ID. Therefore, the temporary ID for one user would not be applicable to another user. Further, session data may be used to create a unique temporary ID. Therefore, the temporary ID for one session would not be applicable to another session. Any combination of individual user data, session data, alphanumerics, and/or characters may form the temporary ID.

In an example embodiment, transactions may be “per use”, and the call to unlock the temp ID may essentially void reuse. For example, “www.aci-host.com?appended-info=tempID”, where temp ID is guaranteed unique ID for 64 alphanumeric characters, may, in this example, represent all data stratified by purchase threshold (e.g., an ad-host can decide to purchase different levels of information). Once the temp ID has been accessed, that particular temp ID may be voided for future use and never used again or not used for an extended period of time. In some embodiments, the temp ID and access to it would contain the transaction counts and/or tracking information.

If the web application 192 wishes to unlock the temp ID and receive the user-specific information associated with the modified user input 170, it may send an indication 180 to the unlock module 193. The unlock module 193 then unlocks the temp ID and sends user-specific information 182 to the web application 192. For example, where the modified user input 170 includes an indication of venue=10, the unlock module 193 may unlock the temporary ID “10” and send the web application 192 information that “10” refers to a luxury hotel. In one embodiment, the web application 192 uses a service implemented by the module 150 to look up the user-specific information associated with the temporary ID.

With the user-specific information, the web application 192 may modify the content of its webpage. For example, if an ad-host 160 learns that a user 110 is at a luxury hotel, the ad-host 160 may display luxury advertisements on its webpage. As another example, a search engine may append a user's search with user-specific information. For instance, if a user 110 submitted a query for food, www.searchengine.com/?query=food, the search engine may display results for www.searchengine.com/?query=food?venue=luxury, knowing that the user is at a luxury hotel. Accordingly, the user 110 may receive a webpage 191, 195 with improved advertising according to an example embodiment.

According to an example embodiment, the temp ID is valid only for a certain number of sessions, a certain amount of time, or a combination thereof. For example, the temp ID may be valid for (1) five sessions (2) five minutes or (3) five sessions or five minutes, whichever lasts longer. In one embodiment, when the temp ID expires, module 150 invalidates the temp ID. Using an invalidated temp ID causes the web application 192 to receive no data or inaccurate data about the user, according to an example embodiment. In one embodiment, after the temp ID expires, another fee by the web application 192 needs to be provided for a valid temp ID.

In one embodiment, the temp ID is valid only for one session. Thus, every time a user 110 submits a new user input 140, the web application 192 needs to pay another fee for a valid temp ID to obtain accurate user-specific information. In one embodiment, the temp ID is valid until the user 110 logs off the network access system 142. When the user 110 logs back on, the web application 192 must pay another fee for a valid temp ID.

In various embodiments, the web application (e.g., on behalf of the advertiser) may pay for user-specific information under a variety of payment models. For example, in some embodiments the web application may purchase information under a “pay-to-play” model, in which a fee is paid per unlock. The fee may be identified as a set price per 1000 unlock requests. In some embodiments, the unlock request may deactivate the temp ID and may be used to store the access data record detail.

In some embodiments, the advertiser/information purchaser associated with the web application may purchase information under a subscription model (e.g., with a weekly, monthly, or yearly periodic subscription fee). For example, the advertiser/information purchaser associated with the web application may subscribe and have access to (via the web application) an unlimited number of unlock requests for a given time period. In some embodiments, an ad-host ID needs to be enabled to maintain the subscription, and a detection by the system of the failure to pay would in turn cause the system to deactivate the subscription account. In some embodiments, site data may change periodically to avoid reuse beyond a subscription term.

In some embodiments, the advertiser/information purchaser associated with the web application may pre-pay or purchase in bulk a set number of unlock requests. In some embodiments, multiple repeat searches for the same words from the same IP address may be tracked regardless of session. For example, if a user closes a browser or does not have cookies enabled, yet searches for the same term on multiple occasions, this can be identified as the same user based on IP address. In some embodiments, the advertiser/information purchaser associated with the web application need only pay one time to unlock a temp ID associated with this user and this query, even if submitted multiple times.

In one embodiment, a temp ID is valid only for a certain amount of time. After that amount of time elapses, the web application 192 must pay another fee for a valid temp ID. When a temp ID is valid for a certain amount of time, the temp ID may expire in the middle of a session or before the session is over. Thus, the web application 192 may optionally be required to pay fees multiple times during the same session for the correct user-specific information. In one embodiment, after the allotted time expires, the module 150 forces a new session before the session would have otherwise terminated. The module 150 may force a new session by automatically refreshing the user's browser. If the web application 192 desires the correct user-specific information for the new session, it must pay another fee according to an example embodiment.

The web application 192 may choose a prearranged fee package, or create its own fee package, according to an example embodiment. As an example, a fee package may include five valid temp IDs, where each temp ID is valid for one session, and each temp ID can be used at any time.

In one embodiment, module 150 automatically invalidates the temp ID after a certain amount of sessions and/or time, such that the module 150 determines the web application's 192 payment pattern. For example, if the module 150 automatically invalidates the temp ID every minute, the web application 192 must pay for a new valid temp ID every minute in order to obtain accurate user-specific information.

The temp ID may be invalidated in any number of ways. It will be appreciated that the temp ID may be invalidated by utilizing any combination of the disclosed methods and/or using other techniques.

In the following examples, the previous label is “venue,” the previous temporary ID is “10”, and the previous user description is “luxury hotel.” In other words, venue=10, where “10” refers (and/or temporarily refers) to “luxury hotel.”

The temp ID may be invalidated by changing the temp ID associated with the previous label and/or user-specific information. For example, where previously “10” was associated with “venue” (venue=10), now “20” is associated with “venue” (venue=20). As another example, where previously “10” was associated with “luxury hotel,” now “20” refers to “luxury hotel.” In order to obtain the correct temp ID, venue=20, the web application 192 needs to pay another fee according to an example embodiment. Attempting to use the now invalid temp ID venue=10 will return inaccurate user-specific information according to one embodiment.

The temp ID may also be invalidated by associating the old temp ID with a null value or inaccurate data. For example, where “10” previously referred to “luxury hotel,” it may now refer to {null} or inaccurate data (e.g., reality television shows). Thus, attempting to use the now invalid temp ID venue=10 will return inaccurate user-specific information.

In one embodiment, the append module 194 appends the user input 140 with an invalid temp ID after a temp ID expires. An invalid temp ID may comprise an expired temp ID (e.g. venue=10) or any temp ID that returns inaccurate data about the user or any data that does not apply to the user. In addition, the append module 194 may cease appending the user input 140 with any temp ID after a temp ID expires. Thus, if a web application 192 desires to access correct user-specific information, the application 192 may cause a fee to be paid for a valid temp ID according to an example embodiment.

In one embodiment, the web application 192 is optionally required to pay a fee to unlock the temp ID. An unlock fee may be required for a certain number of sessions, a certain amount of time, or a combination of thereof. Without the unlock feature, a web application 192 will not be able to decipher what user-specific information it was that the temp ID referred to.

In one example embodiment, the web application 192 may need to pay an unlock fee, but is not required to pay a fee for a valid temp ID. Even a valid temp ID needs to be unlocked if it is to provide accurate user-specific information according to one embodiment. Therefore, even if a valid temp ID is given to a web application 192 for free, the web application 192 must still pay an unlock fee in order to obtain accurate user-specific information. In one embodiment, a valid temp ID is free, but an unlock fee needs to be provided.

In one embodiment, an unlock fee needs to be provided, and the value of the temp ID changes (e.g. venue=10 changes to venue=30) after a certain number of sessions, certain amount of time, or a combination thereof. After the value of the temp ID changes, the append module 194 continues to append the correct valid temp ID (e.g. venue=30) according to one embodiment, but a fee needs to be provided to unlock the temp ID. If the web application 192 attempts to use an old temp ID (e.g. venue=10), the web application 192 receives null or inaccurate user-specific information. In addition, the previous temp ID (e.g. venue=10) may be invalidated. In one embodiment, the value of the temp ID changes every time a web application 192 is due to pay an additional unlock fee. In one embodiment, the previous temp ID is invalidated every time a web application 192 is due to pay an additional unlock fee.

In one embodiment, the web application 192 needs to pay a fee for a valid temp ID, but is not required to pay an unlock fee. Unlocking an invalid temp ID causes the web application 192 to receive inaccurate or no data about the user. Therefore, even if the temp IDs are unlocked for free, the web application 192 must still pay a fee for a valid temp ID in order to obtain accurate user-specific information.

In one embodiment, the web application is not charged for any valid temp ID fees or unlock fees, but is charged for a certain amount of time.

Any combination of a valid temp ID fee, an unlock fee, and/or a time limit fee or subscription may be utilized. For example, a web application 192 may need to pay both a valid temp ID fee and an unlock fee. In order to ensure both fees are paid and received, when a web application 192 fails to pay, the temp ID is invalidated and the unlock feature is blocked (or turned off, inactivated, disabled, etc.) according to an example embodiment. As used herein, “invalidate” shall refer to block, turn off, inactivate, disable, any similar term, or any combination thereof. If only one fee needs to be provided (e.g. unlock fee), when a web application 192 fails to pay (e.g. on behalf of its operation), only the feature for which the fee was needed (e.g. an unlock fee) needs to be invalidated. In one embodiment, the feature for which a fee was not required (e.g. valid temp ID fee) is also invalidated. Other examples of fee structures, which the web application 192 may need to pay, include: an unlock fee for five sessions and a valid temp ID fee for five sessions, both fees for one session and a valid temp ID fee only for the remaining sessions, etc. In addition, a time limit may be factored into any of these fee structures (e.g. unlock feature valid for five minutes).

Whenever any type of fee is not paid, the module 250 may also block all ads (or a subset thereof) from reaching the user 110. The module 250 may block pop-ups and prevent ads from being displayed on a webpage. The module 250 may block all ads (or a subset thereof) in addition to or instead of inactivating the unlock feature and/or temp ID feature.

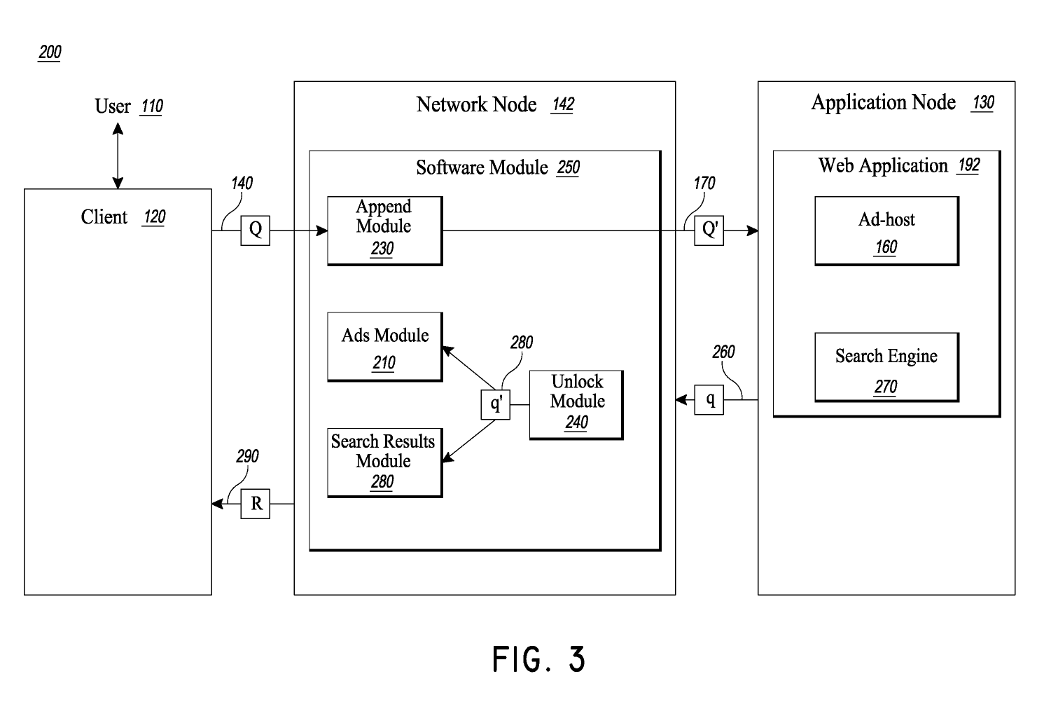

Referring to FIG. 3, an example embodiment includes a network node 142 with software 250 to monitor and modify data packets sent between the user 110 and the application node 130. As illustrated in FIG. 3, the module 250 includes an append module 230, unlock module 240, an ads module 210, and a search results module 220. The append module 230 appends a user input 140 with a label (e.g. venue) and a locked temporary ID (e.g. 1). The unlock module 240 unlocks the temporary ID (e.g. 10), revealing user-specific information (e.g. user is at a luxury hotel). The ad module 210 seamlessly replaces ads on a webpage with other ads. The search results module 220 adjusts the search results from a user query, by re-ordering the list of search results, adding a search result that would not have been listed otherwise, and/or removing a search result that would have been listed otherwise. The ad module 210 and search results module 220 may be used in combination with each other. Replacing ads and adjusting search results is described in the patent application Methods and Systems for Searching, Selecting, and Displaying Content, U.S. application Ser. No. 12/728,037, filed Mar. 19, 2010, the entirety of which is incorporated herein by reference.

In the example below, a user 110 at a luxury hotel submits a user input with respect to a website (e.g. www.adhost.com). The luxury hotel is the user-specific information in this example. Continuing the example, the append module 230 receives the user input 140 www.adhost.com and appends the user input 140 with a label and a locked temporary ID thereby forming a modified query 170, www.adhost.com/?venue=10. The appropriate web application 192, in this case the ad-host website 160, then receives the modified query 170, and learns that user-specific information about the venue is available. If the ad-host 160 wishes to utilize the user-specific information, it may send an indication 260 to the unlock module 240. The unlock module 240 may then unlock the temporary ID of “10,” revealing that the user is at a luxury hotel. The unlock module 240 may then send the unlocked query 280 to the ads module 210. Thus, the ads module 210 receives the unlocked query 280 www.adhost.com/?venue=luxury_hotel. The ads module 210 then replaces the ads on the website according to the user-specific information. For example, www.adhost.com now displays only luxury ads.

In some embodiments, the ads module 210 may permit the ads served by the ad-host 160 (which have been improved in view of the user-specific information provided) to be displayed. In some embodiments, the ads module 210 may replace only advertisements that are not associated with the ad-host 160, for example if other ads are included on the page but were not a subject of the unlocking transaction. For example, in some embodiments the ad-host 160 (e.g., on behalf of an advertiser/information purchaser) may pay to unlock a temp ID for a single ad, but due to ads module 210 replacement of other ads, the ad-host 160 may have the opportunity to display multiple ads.

In some embodiments, the temp ID may be unlocked in an outbound request based on an existing subscription agreement. For example, if www.searchengineA.com is a subscription customer, then a temp ID with an outbound request to searchengineA.com may be unlocked in the outbound request. If www.searchengineA.com ceases to be in good standing (e.g., if they stop paying subscription fees), this unlocking of outbound requests can be terminated.

In some embodiments, the temp ID remains locked with the outbound request. An ad-host may then be required to initiate a call to the software module requesting that the temp ID be unlocked. In some embodiments, the ad-host may be required to present credentials, for example by indicating that the requestor is www.searchengineA.com and is requesting that temp ID abc123xyz be unlocked. In some embodiments, the unlocked temp ID may be communicated to the ad-host via an API or webservice rather than providing an updated URL that includes the unlocked temp ID.

In some embodiments, the ad-host may be provided with its own unlock module or software that continues to function only so long as the ad-host remains in good standing (e.g., continues paying the corresponding fees). For example, while the ad-host continues to pay subscription fees, it may employ its own unlock module or software to unlock temp IDs. This arrangement may provide for improved performance and efficiency.

In some embodiments, the unlock process may require a private key pair. For example, the ad-host may be provided with a first private key that must be used in conjunction with another private key (held by the unlock module, for example) in order to unlock the temp ID. This enables the unlock module to deactivate the unlock capability of any particular ad-host by deactivating or changing the corresponding private key, in which case any data retrieved would be unintelligible to the ad-host.

In the example below, a user 110 at a luxury hotel submits a user input 140, in the form of a query, for food at a search engine. The luxury hotel is the user-specific information in this example. Continuing the example, the append module 230 receives the query 140 www.searchengine.com/query=food. The append module 230 then sends the appended locked query 170, www.searchengine.com/query=food?venue=10, to the applicable web application 192, in this case the search engine website 270. The search engine website 270, learning that user-specific information about the venue is available, may send an indication to the unlock module 240 that it wishes to utilize the user-specific information. Thus, the unlock module 240 unlocks the query and sends the unlocked query 280, www.searchengine.com/query=food?venue=luxury, to the search results module 220. The search results module 220 then returns 100 search results for www.searchengine.com/query=food?venue=luxury. The search results module 220 may also send to the user 110 a modified listing of search results. For example, the search results module 220 may re-order the listing of search results, add a search result that would not have been listed otherwise, and/or remove a search result that would not have been listed otherwise.

It will be appreciated that the ads module 210 and the search results module 220 can be used in combination. For example, if a webpage includes both ads and a listing of search results, the unlocked query may be sent to both modules 210, 220.

As illustrated, the web application 192 is informed that user-specific information is available by the appended user input 170 which includes a label and a locked temporary ID. While the web application is informed of the label (e.g. venue), the web application 192 is not informed of the user-specific information is (e.g. luxury hotel) because the temporary code is unlocked internally at the network node 142. The unlock module 240 unlocks the temporary code and sends the unlocked query 280 to the ads module 210 and/or the search engine module 220, all at the network node 142. Thus, the user-specific information remains hidden from the web application 192. With the temporary code unlocked, and the user-specific information, the ads module 210 and/or the search engine module 220 sends to the user 110 a webpage with improved ads based on the user-specific information.

In an example embodiment, the web application 192 needs to pay a fee for the module 250 to serve improved ads. As discussed above, the web application 192 may need to pay a temp ID fee, an unlock fee, a time limit fee, or any combination thereof. The temp ID fee and the unlock fee may be valid for a certain number of sessions, a certain amount of time, or a combination thereof.

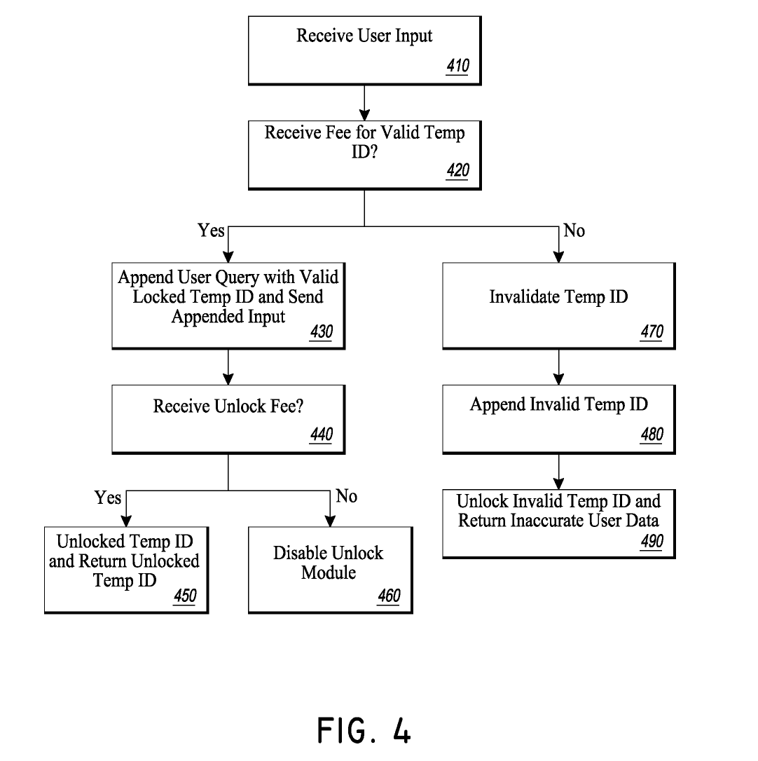

FIG. 4 illustrates an example process for providing user-specific information, which may optionally be implemented by software installed at, and executed by a network node or otherwise. At state 410, the module receives a user input. At state 420, the module determines whether a fee for a valid temp ID has been paid, for example, by a web application. If the fee has been paid, at state 430 the module appends the user input with a valid and locked temporary ID, and sends the appended user input to a web-application. At state 440, the module determines whether an unlock fee has been paid. If it has been paid, the module unlocks the temp ID and returns the unlocked temp ID and the associated user-specific information. In one embodiment, the module returns the unlocked temp ID to a web application. In another embodiment, the module returns the unlocked temp ID to an ads module 210 and/or search results module 280. If an unlock fee is not paid, the module disables the unlock module at state 460.

Returning to state 420, if a valid temp ID is not paid, the module may invalidate the temp ID at state 470. In one embodiment, at state 480 the module also appends the invalid temp ID to the user query. Further, at state 490, the module may also unlock the invalid temp ID and return inaccurate user data.

In one embodiment, a valid temp ID fee is not required, but an unlock fee needs to be provided. Thus, state 420 may optionally not be performed (determining whether a valid temp ID has been paid) and the process may proceed from state 410 (receiving a user query) to state 430 (appending the user input with a locked temp ID).

In one embodiment, an unlock fee needs to be provided, and a valid temp ID fee is not required. Thus, state 440 may optionally not be performed (determining whether an unlock fee has been paid) and the process may proceed from state 430 (appending the user query with a locked temp ID) to state 450 (unlocking the temp ID).

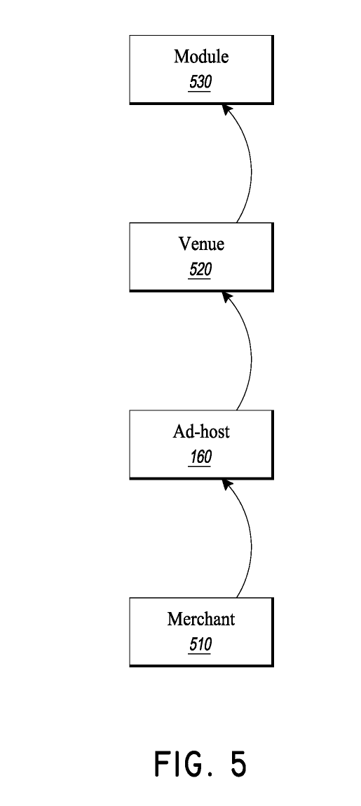

FIG. 5 illustrates a revenue model according to an example embodiment. Referring to FIG. 5, a merchant 510 may submit a fee to an ad-host 160 so that the ad-host 160 displays advertisements for the merchant 510 on the ad-host 160 website. The ad-host 160, in turn, may submit a portion of that fee to a venue 520 in order to utilize specific information about a user at the venue 520 and serve improved ads to the user at the venue 520. The venue 520, in turn, may submit a portion of that fee to acquire software 530. The module 530 comprises a system for requesting fees from an ad-host 160 and receiving fees from the ad-host 160 as described herein. The module 530 may thus allow the venue 520 to acquire revenues from the ad-host 160. As noted above, in some embodiments payment may be sent from the ad-host to the module, which may then in turn pay the venue.

In an example embodiment, a user may navigate to a search engine page or a page having a surrogate search bar (e.g., a search bar provided by Google or another search provider). The user may enter search terms. A software module (which may be in the network (e.g., a proxy) or event driven (e.g., an add-on)) may act on the search request before sending it to the receiver. The software module may concatenate information that enhances the relevancy and therefore the value of that search request. However, the information may be locked using a unique and possibly highly volatile key. The information may be unlocked in exchange for a fee. The lock and/or unlock functions may each be hosted, installed, or localized (e.g., resides in a distributed server). In some embodiments, unlocking may be enabled such that a current customer is able to unlock the locked information independently, and fees may be charted to the customer based on concatenation volumes, trends, etc.

Certain embodiments may be implemented via hardware, software stored on media, or a combination of hardware and software. For example, certain embodiments may include software/program instructions/modules stored on tangible, non-transitory computer-readable medium (e.g., magnetic memory/discs, optical memory/discs, RAM, ROM, FLASH memory, other semiconductor memory, etc.), accessible by one or more computing devices configured to execute the software (e.g., servers or other computing device including one or more processors, wired and/or wireless network interfaces (e.g., cellular, Wi-Fi, Bluetooth, T1, DSL, cable, optical, or other interface(s) which may be coupled to the Internet), content databases, customer account databases, etc.). Data stores (e.g., databases) may be used to store some or all of the information discussed herein in memory.

Thus, systems and methods for providing user-specific information and utilizing user-specific information are described. Operators of network access devices are optionally compensated for providing network access by the provision of such user-specific information. The user-specific information may be used to target advertising to the user.

By way of example, a given computing device may optionally include user interface devices, such as some or all of the following: one or more displays, keyboards, touch screens, speakers, microphones, mice, track balls, touch pads, tilt sensors, accelerometers, biometric sensors (e.g., fingerprint or face recognition sensors for authenticating a user) printers, etc. The computing device may optionally include a media read/write device, such as a CD, DVD, Blu-ray, tape, magnetic disc, semiconductor memory, or other optical, magnetic, and/or solid state media device. A computing device, such as a user terminal, may be in the form of a general purpose computer, a personal computer, a laptop, a tablet computer, a mobile or stationary telephone, an interactive television, a set top box coupled to a display, etc. Certain embodiments may be able to conduct hundreds (or more) of transactions and processes described herein within a second.

While certain embodiments may be illustrated or discussed as having certain example components, additional, fewer, or different components may be used. Process described as being performed by a given system may be performed by a user terminal or other system or systems. Processes described as being performed by a user terminal may be performed by another system. Data described as being accessed from a given source may be stored by and accessed from other sources. Transmissions described herein may be via a wired and/or wireless network or other communications link. Further, with respect to the processes discussed herein, various states may be performed in a different order, not all states are required to be reached, and fewer, additional, or different states may be utilized.

User interfaces described herein are optionally presented (and user instructions may be received) via a user computing device using a browser, other network resource viewer, or otherwise. For example, the user interfaces may be presented (and user optionally instructions received) via an application (sometimes referred to as an “app”) installed on the user's mobile phone, laptop, pad, desktop, television, set top box, phone, or other terminal. Various features described or illustrated as being present in different embodiments or user interfaces may be combined into the same embodiment or user interface. While reference may be made to webpages, other types of electronic documents (including those not based on HTML) may be used. While reference may be made to websites, other network resources may be used.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein. Further, embodiments may include several novel features, no single one of which is solely responsible for the embodiment's desirable attributes or which is essential to practicing the systems, devices, methods, and techniques described herein. In addition, various features of different embodiments may be combined to form still further embodiments. For example, aspects found in different user interfaces may be combined to form still further user interface.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A method of processing a uniform resource locator (URL) request from a user and providing venue information to an application node, the method comprising:
receiving, at a network node, the URL request from a user terminal;
causing, at least in part, a temporary identification to be associated with the URL request, wherein the temporary identification is associated with venue information regarding a venue associated by location with the user terminal;
automatically appending the URL request with at least a portion of the temporary identification, wherein the temporary identification is locked;
transmitting the modified URL request, including the locked temporary identification over a network to an application node;
receiving at the network node, from the application node, a request to unlock the locked temporary identification; and
at least partly in response to the request to unlock the locked temporary identification, transmitting the venue information to the application node.

2. The method of claim 1, wherein the URL request may be received from the user terminal directly, indirectly, or relayed.

3. The method of claim 1, wherein the user terminal is remote from the network node and the user input is received over a network connection.

4. The method of claim 1, further comprising receiving, from the application node, a fee prior to transmitting the venue information to the application node.

5. The method of claim 1, wherein the venue information comprises the location of the venue.

6. The method of claim 1, wherein the venue information comprises information regarding customers of the venue.

7. The method of claim 1, wherein the temporary identification expires after a first duration, after which the temporary identification is no longer associated with the venue information.

8. The method of claim 1, further comprising causing, at least in part, the temporary identification to cease to be associated with the venue information after a first duration.

9. The method of claim 8, wherein the first duration comprises a number of sessions.

10. The method of claim 8, wherein the first duration comprises a period of time.

11. The method of claim 1, further comprising:
storing the temporary identification and associated venue information in a database; and
at least partly in response to receiving the request to unlock the temporary identification, accessing the database to retrieve the associated venue information associated with the temporary identification;

12. The method of claim 1, wherein the temporary identification and associated venue information are stored in a database, the method further comprising:
receiving, at the network node, consent from a user of modification of the URL request;
storing the temporary identification and associated venue information in a database;
at least in part in response to receiving the request to unlock the temporary identification, accessing the database to retrieve the associated venue information associated with the temporary identification;
causing, at least in part, a withdrawal or a debit to be made with respect to an account associated with the application node at least partly in response to transmitting the venue information; and
generating a report indicating that the venue information has been sent to the application node.

13. A method of processing input from a user and providing user information to an application node, the method comprising:
receiving, at a network node, the user input from a user terminal;
causing, at least in part, a temporary identification to be associated with the user input, wherein the temporary identification is associated with information about the user;
modifying the user input based at least in part on the temporary identification;
transmitting the modified user input to an application node;
receiving from the application node a request to unlock the temporary identification; and
transmitting the user information user to the application node.

14. The method of claim 13, wherein the user input comprises a keyword query.

15. The method of claim 13, wherein the user input comprises a uniform resource locator (URL) request.

16. The method of claim 13, wherein the user input comprises navigation by the user to a web page.

17. The method of claim 13, wherein the user terminal is remote from the network node and the user input is received over a network connection.

18. The method of claim 13, wherein modifying the user input comprises appending the temporary identification to the user input.

19. The method of claim 13, wherein modifying the user input comprises appending characters to the user input associated with the temporary identification.

20. The method of claim 13, wherein the temporary identification comprises user data or session data.

21. The method of claim 13, wherein the user information comprises information regarding a venue at which the user terminal is located.

22. The method of claim 13, wherein the user information comprises purchasing history of the user.

23. The method of claim 13, wherein the user information comprises demographic information about the user.

24. The method of claim 13, wherein the user information comprises occupation of the user.

25. The method of claim 13, wherein the temporary identification expires after a first duration, after which the temporary identification is no longer associated with the user information.

26. The method of claim 25, further comprising causing, at least in part, the temporary identification to cease to be associated with the user information after a first duration.

27. The method of claim 26, wherein the first duration comprises a number of sessions.

28. The method of claim 26, wherein the first duration comprises a period of time.

29. Tangible, non-transitory media configured to store a program that when executed by a processor is configured to perform operations, comprising:
receiving, at a network node, a user input from a user terminal;
causing, at least in part, a temporary identification to be associated with the user input, wherein the temporary identification is associated with information about the user;
modifying the user input based at least in part on the temporary identification;
transmitting the modified user input to an application node;
receiving from the application node a request to unlock the temporary identification; and
transmitting the user information user to the application node.

30. The media as defined in claim 29, wherein the user input comprises a keyword query.

31. The media as defined in claim 29, wherein the user input comprises a uniform resource locator (URL) request.

32. The media as defined in claim 29, wherein the user input comprises navigation by the user to a web page.

33. The media as defined in claim 29, wherein the user terminal is remote from the network node and the user input is received over a network connection.

34. The media as defined in claim 29, wherein modifying the user input comprises appending the temporary identification to the user input.

35. The media as defined in claim 29, wherein modifying the user input comprises appending characters to the user input associated with the temporary identification.

36. The media as defined in claim 29, wherein the temporary identification comprises user data or session data.

37. The media as defined in claim 29, wherein the user information comprises information regarding a venue at which the user terminal is located.

38. The media as defined in claim 29, wherein the user information comprises purchasing history of the user.

39. The media as defined in claim 29, wherein the user information comprises demographic information about the user.

40. The media as defined in claim 29, wherein the user information comprises occupation of the user.

41. The media as defined in claim 29, wherein the temporary identification expires after a first duration, after which the temporary identification is no longer associated with the user information.

42. The media as defined in claim 41, the operations further comprising causing, at least in part, the temporary identification to cease to be associated with the user information after a first duration.

43. The media as defined in claim 42, wherein the first duration comprises a number of sessions.

44. The media as defined in claim 42, wherein the first duration comprises a period of time.
